(19) United States
(12) Patent Application Publication
(10) Pub. No.: US 2012/0021107 A1
(43) Pub. Date: Jan. 26, 2012

(54) METHOD AND APPARATUS FOR PROCESSING PRODUCE

(76) Inventors: Robert Andrew Knowlton, Santa Fe, NM (US); Cedric Chastenet de Gery, Santa Fe, NM (US)

(21) Appl. No.: 12/842,796

(22) Filed: Jul. 23, 2010

(51) Int. Cl. B65B 55/12; B65B 31/04; A47J 43/00; A23L 2/46

(52) U.S. Cl. 426/394; 426/407; 53/510; 99/537

(57) ABSTRACT

A method and apparatus to create a product, such as, but not limited to, a fruit juice, vegetable juice, fruit puree, soup, fruit cup or a combination of fruit and vegetables in solid or liquid form with extended shelf life without deterioration of color, texture, nutritional profile, or flavor which are typically associated with conventional processing methods. The disclosed apparatus and method avoids oxidation by creating an oxygen-free environment for produce processing followed by pasteurization treatment. The disclosed apparatus and method avoids degradation of nutrition content by maintaining stable processing temperatures and avoiding oxidation throughout all processing steps. Based on the type of produce to be processed, the particular processing steps are customized in order to optimize the nutritional profile of the particular fruit or vegetable product to be produced.

### BACKGROUND OF THE INVENTION

1. Field of the Invention

The invention pertains, in general, to processing produce into a juice or food product, and in particular, to processing produce into a juice or food product without degradation of color, flavor, or nutritional profile.

2. Description of the Background Art

One of the primary concerns when processing produce like fruits or vegetables is the loss of color, flavor, and nutritional profile that occurs during the various processing steps needed to convert the produce into a juice or food product for the consumer. Two key phenomena are involved when considering color, flavor, and nutritional degradation during food processing. These two phenomena are degradation of color, flavor, and nutritional profile due to exposure to air (oxidation) and exposure to elevated temperatures (cooking). For example, a conventional juice processing apparatus involves several components, like a grinder, fruit press, pasteurization method, packaging mechanism, or a transport system. Each of these individual components allow processed produce to become exposed to air. In the example of apple juice processing, even limited exposure of processed apples to air can cause considerable browning, loss of nutritional content, loss of flavor and loss of health benefits associated with polyphenols. Some processing technologies contain select components, like an oxygen-free fruit press, that convert produce into a juice in an environment free from oxygen contamination. These systems are incomplete, however, due to the fact that during further processing the processed produce will come in contact with an oxygen-rich environment that will lead to nutritional degradation through oxidation. In most juice processing scenarios, significant pre-treatment and/or grinding is necessary before the produce is ready for introduction to the press. During the typical pre-treatment and/or grinding steps, processed produce comes in direct contact with an oxygen-rich environment that leads to significant nutritional and color degradation.

In regard to loss of color, flavor, and nutritional content through exposure of produce to elevated temperatures; typical pasteurization techniques are carried out under temperatures significantly elevated above room temperature. In conventional pasteurization techniques, internal temperature of processed produce can exceed 100° C. At these elevated temperatures, the nutritional content, flavor, and color of the processed produce, and the juice that is produced, are severely compromised. Some juice processing techniques rely upon flash pasteurization. Flash pasteurization techniques involve exposing produce to high temperatures (˜100° C.) for short periods of time (usually 15-30 seconds). Even short exposure to elevated temperature, will lead to significant color and flavor loss and nutritional degradation of the processed produce. Also, conventional flash pasteurization techniques are applied to produce before packaging occurs. These techniques can lead to significant cross-contamination with the packaging media. Another area of the conventional juice processing apparatus that leads to degradation of the produce is the packaging step. The typical processing system, as is the case for flash pasteurization processes, involves pasteurizing the produce and then packaging the pasteurized juice. During the transfer of the pasteurized produce to the packaging system, possible contamination, through exposure to air, occurs which leads to further degradation and shelf life reduction.

What is needed is a method and apparatus for processing produce that avoids contamination of the produce with oxygen and maintains stable processing temperatures throughout, thus preserving the content, color, and flavor of the original harvested produce throughout the entire food production process.

### SUMMARY OF INVENTION

The present invention provides a method and apparatus for produce processing that avoids degradation of color, taste, or nutritional profile of the produce from the challenges listed above. An embodiment of the present invention provides a method for processing a substance with the following steps: receiving the substance; pressing the substance, wherein the pressing step occurs in a first oxygen-free environment and converts the substance into a liquid; packaging the liquid, wherein the packaging step occurs in a second oxygen-free environment and packages the liquid in a package; and pasteurizing the liquid, while the liquid is contained in the package, wherein the pasteurizing step converts the liquid into a pasteurized liquid, wherein the conversion of the liquid into the pasteurized liquid is executed at a pressure greater than atmospheric pressure. The processing method and apparatus insures stable processing temperatures and negligible exposure to oxygen throughout the liquid production process. An embodiment of the present invention provides an apparatus for processing a substance into a pre-treated substance with the following components: a receiving means for receiving the substance; and a pre-treating means, the pre-treating means connected to the receiving means, for converting the substance into a pre-treated substance, wherein the pre-treating means maintains a first oxygen-free environment; and a packaging means, the packaging means connected to the pre-treating means, for packaging the pre-treated substance in a package, wherein the packaging means maintains a second oxygen-free environment; and a pasteurizing means, the pasteurizing means connected to the packaging means, for pasteurizing the pre-treated substance while the pre-treated substance is contained in the package.

### BRIEF DESCRIPTION OF DRAWINGS

FIG. 1 is a block diagram of an apparatus for converting a substance into a liquid or food product in accordance with an embodiment of the present invention.

FIG. 2a is a flow diagram of a method for converting a substance into a liquid in accordance with an embodiment of the present invention.

FIG. 2b is a flow diagram of a method for converting a substance into a liquid in accordance with another embodiment of the present invention.

FIG. 3 is a block diagram of an apparatus for grinding a substance in accordance with an embodiment of the present invention.

### DETAILED DESCRIPTION OF DRAWINGS

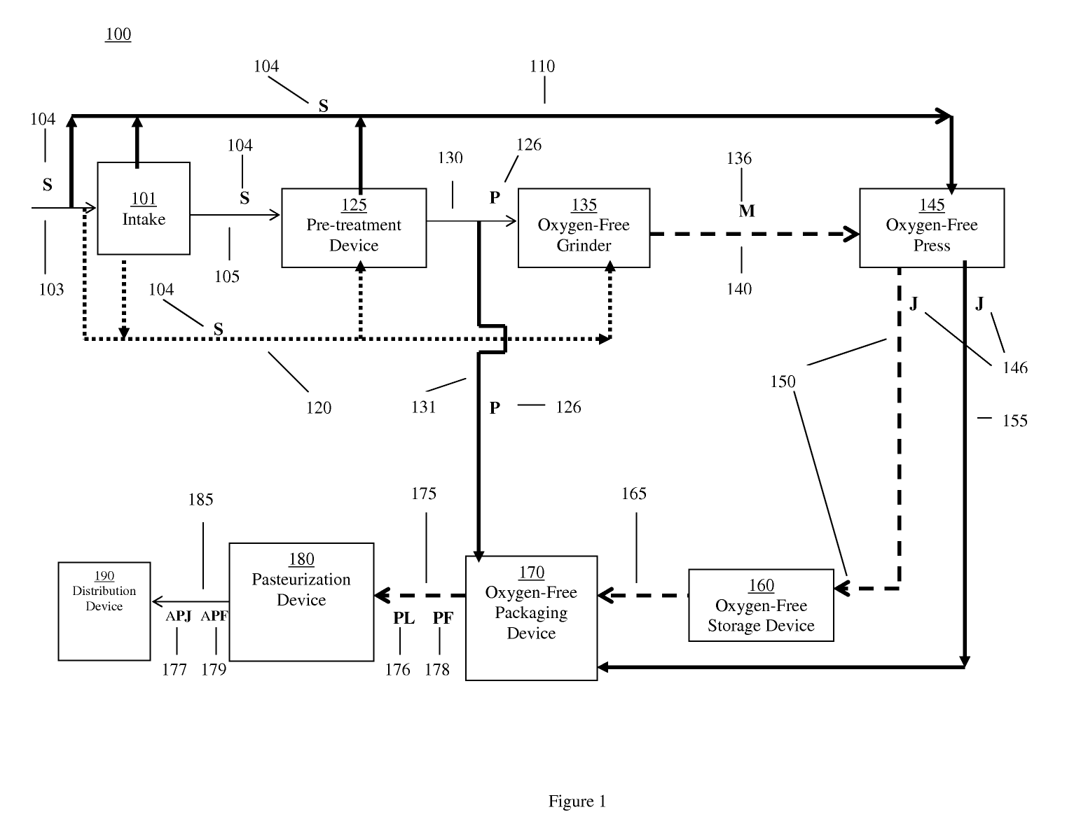

FIG. 1 illustrates a processing apparatus 100 for converting a substance 104 into liquid 146 in accordance with an embodiment of the present invention. Substance 104 is received from a grower and collected via intake line 103 and intake 101. In an embodiment, intake 101 is a controlled atmosphere storage. In an embodiment, intake 101 is a storage environment free from oxygen so that incoming substance 104 is not degraded, through oxidation, by exposure to air. In an embodiment, substance 104 is a fruit. In an embodiment, substance 104 is a fruit or produce selected from, but not limited to, grapes, strawberries, cherries, apples, kiwis, blueberries, raspberries, blackberries, peaches, bananas, apricots, plums, oranges, lemons, limes, grapefruits, cranberries, cucumbers, celery, ginger, carrots, beets, spinach, kale, spirulina, and various herbs and spices. In an embodiment, intake 101 is evacuated of oxygen and substance 104 is stored within intake 101 in order to preserve nutrient content before the processing steps begin. In an embodiment, intake 101 provides a storage environment at a fixed temperature. In an embodiment, intake 101 provides a storage environment at a fixed temperature below room temperature. The exact conditions of intake 101 are determined based on the particular substance 104 to be stored. Certain substances, like kiwis, bananas, or peaches, are preferably exposed to air during this initial storage period such that substance 104 is given significant time to ripen before it is processed. In an alternate embodiment, substance 104 is preferably stored at a fixed temperature, like room temperature. This embodiment is preferable when storing fruit like kiwis, bananas, or peaches. In this embodiment, substance 104 is given sufficient time to ripen prior to substance 104 being processed. The storage time and storage conditions for the particular embodiment of substance 104 can be customized to fit the specific needs of the type of substance 104 that is to be processed.

In an embodiment, substance 104 is transported from intake 101 to pre-treatment device 125 by way of first transport means 105. Pre-treatment device 125 converts substance 104 into pre-treated substance 126. In an embodiment, first transport means 105 is a sealed, oxygen-free conveyer system. In this embodiment, the nutrient content of substance 104 is kept stable during the time that it is transported from intake 101 to pre-treatment device 125. Once substance 104 arrives at pre-treatment device 125, several pre-treatment processes can be carried out depending on the nature of substance 104 to be processed. In an embodiment, substance 104 is cleaned by pre-treatment device 125. In an embodiment, substance 104 is sorted and cleaned by pre-treatment device 125. In an embodiment, substance 104 is sorted, cleaned, and cored by pre-treatment device 125. In an embodiment, substance 104 is sorted, cleaned, and de-stoned (or pitted) by pre-treatment device 125. In an embodiment, substance 104 is sorted, cleaned, and de-stemmed by pre-treatment device 125. In an embodiment, substance 104 is sorted, cleaned, and peeled by the pre-treatment device. In an embodiment, substance 104 is frozen by pre-treatment device 125. In an embodiment, pre-treatment techniques are chosen by one skilled in the art based on the type of substance 104 to be processed such that the quality of the processed substance is optimized. In an embodiment, pre-treatment device 125 converts substance 104 into pre-treated substance 126 in an environment free from oxygen. In an embodiment, pre-treated substance 126 is a fruit or vegetable puree or pieces of fruits or vegetables.

In an embodiment, after leaving pre-treatment device 125, pre-treated substance 126 is transported by way of second transport means 130 to oxygen-free grinder 135. Oxygen-free grinder 135 converts pre-treated substance 126 into mash 136. In an embodiment, oxygen-free grinder 135 is equipped for grinding various substances like fruits and vegetables into a mash. Preferably, oxygen-free grinder 135 is an environment that is free of any contamination by oxygen. In an embodiment, second transport means 130 is a conveyer system that is free of any oxygen contamination. In the case of transporting certain pre-treated substances generated from fruits like apricots, bananas, cherries, blueberries, mangos, and papaya, it is preferable to transport such pre-treated substances in an oxygen-free conveyer in order to limit degradation of the pre-treated substance by oxidation.

In an embodiment, after pre-treated substance 126 is converted to mash 136, first oxygen-free transport means 140 transports mash 136 to oxygen-free press 145 for further processing. Oxygen-free press 145 converts mash 136 into liquid 146 in an environment that is free of any contamination by oxygen. In an embodiment, first oxygen-free transport means 140 comprises a conveyer system for transporting objects in an environment that is free of any oxygen contamination. In an embodiment, during the conversion of mash 136 to liquid 146, oxygen-free press 145 produces pumice or food by-product. In an embodiment, the pumice is collected and recycled for fertilizing needs. In another embodiment, pumice is used as an ingredient for other food products. In an embodiment, pumice is used as an additive to be reconstituted into processed product (i.e. fiber). In an embodiment, pumice is used on its own as a new food product.

In an embodiment, after exiting oxygen-free press 145, liquid 146 is transported by second oxygen-free transport means 150 to oxygen-free storage device 160. In an embodiment, second oxygen-free transport means 150 comprises food grade metal or plastic. In an embodiment, second oxygen-free transport means 150 comprises a steel tube for food grade processing for transporting substance in an environment that is free of any oxygen contamination. In an embodiment, oxygen-free storage device 160 is purged free from oxygen contamination through the use of dry ice. In an embodiment, oxygen-free storage device 160 is purged free from oxygen contamination through the input of nitrogen or other gas. In an embodiment, oxygen-free storage device 160 is an agitator used for stifling juice 146 until further processing is needed. In an embodiment, oxygen-free storage device 160 is a controlled atmosphere storage tank. In this embodiment, the storage temperature and storage pressure for oxygen-free storage device 160 are closely controlled in order to optimize the nutrient and color content of liquid 146. In an alternate embodiment, after exiting oxygen-free press 145, liquid 146 by-passes oxygen-free storage device 160 and is transported directly to oxygen-free packaging device 170 by way of third by-pass means 155. In an embodiment, third by pass means 155 comprises a conveyer system for transporting substance in an environment that is free of any oxygen contamination.

In an embodiment, after exiting oxygen-free storage device 160, liquid 146 is transported to oxygen-free packaging device 170 by way of third oxygen-free transport means 165. In an embodiment, third oxygen-free transport means 165 comprises a pressurized tube. In an embodiment, third oxygen-free transport means 165 comprises a system for transporting liquid 146 in an environment that is free of any oxygen contamination. In an embodiment, oxygen-free packaging device 170 comprises an input tube that receives liquid 146 from third oxygen-free transport means 165. In an embodiment, oxygen-free packing device 170 comprises a pump that provides preferential control over the input flow rate of liquid 146 into a package. The flow rate of liquid 146, as controlled by the pump, can be adjusted based on the size of package and the amount of liquid 146 to be packaged in a given time. In an embodiment, oxygen-free packaging device 170 selects packages for packaging liquid 146 from a variety of packaging media, including, but not limited to, plastic bottles, glass bottles, aluminum bags, aluminum, steel, metal or alloy cans, plastic based bags or pouches, foil based bags or pouches, and tetra packs. In an embodiment, oxygen-free packaging device 170 packages liquid 146 into a variety of packaging media in an environment free from oxygen contamination. In an embodiment, after a package is filled with liquid 146, oxygen-free packing device 170 places a cap or seal on the package and hermetically seals the package with a cap or seal, thus producing packaged liquid 176. In an embodiment, after a package is filled with liquid 146, oxygen-free packing device 170 places a self-dispensing tap on the package and hermetically seals the package with the self-dispensing tap, thus producing packaged liquid 176. Depending on the volume of the order to be processed, any number of units of packages can be filled with liquid 146 and hermetically sealed with a cap or self-dispensing tap. In an embodiment, oxygen-free packaging device 170 stamps labels onto packaged liquid 176 before the packaged liquid 176 exits oxygen-free packaging device 170.

After exiting oxygen-free packaging device 170, packaged liquid 176 is preferably transported by third transport means 175 to pasteurization device 180. Pasteurization device 180 converts packaged liquid 176 into packaged pasteurized liquid 177 through a variety of pasteurization techniques, including, but not limited to, high pressure pasteurization (HPP), flash pasteurization, ohmic pasteurization, non-heat pasteurization and ultraviolet pasteurization. In a preferred embodiment, pasteurization device 180 pasteurizes liquid 146 while liquid 146 is contained in a package. In an embodiment, pasteurization device 180 pasteurizes liquid 146 while liquid 146 is contained in a package comprising a closure system including, but not limited to, a self-dispensing tap or cap. In an embodiment, pasteurization device 180 pasteurizes liquid 146, wherein the pasteurizing step takes place at a pressure greater than atmospheric pressure. In an embodiment, pasteurization device 180 pasteurizes liquid 146, wherein the pasteurizing step takes place at a pressure significantly greater than atmospheric pressure. In an embodiment, pasteurization device 180 pasteurizes liquid 146, wherein the pasteurizing step takes place at a pressure up to 100,000 psi. In an embodiment, pasteurization device 180 liquid 146, wherein the pasteurizing step takes place at room temperature. In an embodiment, pasteurization device 180 pasteurizes liquid 146, wherein the pasteurizing step takes place at a temperature below room temperature. In an embodiment, after liquid 146 is pasteurized by pasteurization device 180, fourth transport means 185 transports packaged pasteurized liquid 177 to distribution device 190 such that the packaged, pasteurized liquid 177 is distributed to customers. In an alternate embodiment, liquid 146 is received by pasteurization device 180, liquid 146 is then pasteurized by pasteurization device 180, then liquid 146 is sealed in a package by oxygen-free packaging device 170 creating packaged pasteurized liquid 177, and then finally packaged pasteurized liquid 177 is distributed to customers. This embodiment is preferable depending on the type of packaging to be used and the type of liquid 146 to be packaged.

In an alternate embodiment, substance 104 bypasses intake 101 by way of first by-pass means 120. In this embodiment, substance 104 bypasses intake 101 in order to maximize the nutrient capacity of substance 104 and begin processing of substance 104 immediately. In this embodiment, substance 104 is received by intake line 103 and directly transported to pre-treatment device 125 by way of first by-pass means 120. Pre-treatment device 125 converts substance 104 into pre-treated substance 126. After this conversion step, pre-treated substance 126 is transported directly to oxygen-free press 145 by way of second by-pass means 110. Oxygen-free press 145 converts pre-treated substance 126 into liquid 146 in an environment that is free of any contamination by oxygen. At this point, liquid 146 is packaged by oxygen-free packaging device 170 and pasteurized by pasteurization device 180. This embodiment is preferable when processing substances like grapes, raspberries, blackberries, cherries, tomatoes. In an embodiment, first by-pass means 120 comprises a system selected from, but not limited to the following: an auger, a conveyor system, metal or plastic piping or tubing, or human labor. In an embodiment, first by-pass means 120 comprises an oxygen-free transport system.

In an alternate embodiment, substance 104 bypasses intake 101 by way of first by-pass means 120. In this embodiment, substance 104 bypasses intake 101 in order to maximize the nutrient capacity of substance 104 and begin processing of substance 104 immediately. In this embodiment, substance 104 is received by intake line 103 and directly transported to pre-treatment device 125 by way of first by-pass means 120. Pre-treatment device 125 converts substance 104 into pre-treated substance 126. After this conversion step, pre-treated substance 126 is transported to oxygen-free grinder 135 by way of second transport means 130. Oxygen-free grinder 135 converts pre-treated substance 126 into mash 136 and then mash 136 is transported to oxygen-free press 145 by way of first oxygen-free transport means 140. Oxygen-free press 145 converts mash 136 into liquid 146 in an environment that is free of any contamination by oxygen. At this point, liquid 146 is then packaged by oxygen-free packaging device 170 and pasteurized by pasteurization device 180. This embodiment is preferable when processing substances like grapes, raspberries, blackberries, cherries, or tomatoes.

In an alternate embodiment, substance 104 bypasses intake 101 and pre-treatment device 125, by way of first by-pass means 120. In this embodiment, substance 104 bypasses intake 101 and pre-treatment device 125 in order to begin processing of substance 104 immediately. In this embodiment, substance 104 is received by intake line 103 and directly transported to oxygen-free grinder 135 by way of first by-pass means 120. Oxygen-free grinder 135 converts substance 104 into mash 136 and then mash 136 is transported to oxygen-free press 145 by way of first oxygen-free transport means 140. Oxygen-free press 145 converts mash 136 into liquid 146 in an environment that is free of any contamination by oxygen. At this point, liquid 146 is then packaged by oxygen-free packaging device 170 and pasteurized by pasteurization device 180. This embodiment is preferable when processing substances like apples or pears.

In an alternate embodiment, substance 104 bypasses intake 101, pre-treatment device 125, and oxygen-free grinder 135, by way of second by-pass means 110. In this embodiment, substance 104 bypasses intake 101, pre-treatment device 125, and oxygen-free grinder 135 in order to begin processing of substance 104 immediately. In this embodiment, substance 104 is received by intake line 103 and directly transported to oxygen-free press 145 by way of second by-pass means 110. Oxygen-free press 145 converts substance 104 into liquid 146 in an environment that is free of any contamination by oxygen. At this point, liquid 146 is packaged by oxygen-free packaging device 170 and pasteurized by pasteurization device 180. This embodiment is preferable when processing certain substances like strawberries, kiwis, grapes, and cherries. In an embodiment, second by-pass means 110 comprises a transport system selected from, but not limited to, an auger, a conveyor system, or human labor. In an embodiment, second by-pass means 110 comprises an oxygen-free transport system.

In an alternate embodiment, substance 104 is received by intake 101 through intake line 103 and stored in intake 101. After substance is stored in intake 101 for a period of time, substance 104 is then transported directly to oxygen-free press 145 by way of second by-pass means 110. Oxygen-free press 145 converts mash 136 into liquid 146 in an environment that is free of any contamination by oxygen. At this point, liquid 146 is then packaged by oxygen-free packaging device 170 and pasteurized by pasteurization device 180. This embodiment is preferable when processing certain substances like kiwis, apricots, or tomatoes.

In an alternate embodiment, substance 104 is received by intake 101 through intake line 103 and stored in intake 101. After substance is stored in intake 101 for a period of time, substance 104 is then transported to pre-treatment device 125 by way of first transport means 105. Pre-treatment device 125 converts substance 104 into pre-treated substance 126. After this conversion step, pre-treated substance 126 is transported directly to oxygen-free press 145 by way of second by-pass means 110. Oxygen-free press 145 converts pre-treated substance 126 into liquid 146 in an environment that is free of any contamination by oxygen. At this point, liquid 146 is then packaged by oxygen-free packaging device 170 and pasteurized by pasteurization device 180. This embodiment is preferable when processing substances like pineapple, melons, oranges, mangos, or papaya.

In an alternate embodiment, substance 104 is received by intake 101 through intake line 103 and stored in intake 101. After substance is stored in intake 101 for a period of time, substance 104 is then directly transported to oxygen-free grinder 135 by way of first by-pass means 120. Oxygen-free grinder 135 converts substance 104 into mash 136 and then mash 136 is transported to oxygen-free press 145 by way of first oxygen-free transport means 140. Oxygen-free press 145 converts mash 136 into liquid 146 in an environment that is free of any contamination by oxygen. At this point, liquid 146 is then packaged by oxygen-free packaging device 170 and pasteurized by pasteurization device 180. This embodiment is preferable when processing substances like apples, pears, or cherries.

In an alternate embodiment, substance 104 is received by intake 101 through intake line 103. After substance is stored in intake 101 for a period of time, substance 104 is then transported to pre-treatment device 125 by way of first transport means 105. Pre-treatment device 125 converts substance 104 into pre-treated substance 126. After this conversion step, pre-treated substance 126 is transported to oxygen-free grinder 135 by way of second transport means 130. Oxygen-free grinder 135 converts pre-treated substance 126 into mash 136 and then mash 136 is transported to oxygen-free press 145 by way of first oxygen-free transport means 140. Oxygen-free press 145 converts mash 136 into liquid 146 in an environment that is free of any contamination by oxygen. At this point, liquid 146 is then packaged by oxygen-free packaging device 170 and pasteurized by pasteurization device 180. This embodiment is preferable when processing substances like peaches or nectarines.

In an alternate embodiment, substance 104 is received by intake 101 through intake line 103. After substance is stored in intake 101 for a period of time, substance 104 is then transported to pre-treatment device 125 by way of first transport means 105. Pre-treatment device 125 converts substance 104 into pre-treated substance 126. After this conversion step, pre-treated substance 126 is transported directly to oxygen-free packaging device 170 by way of second transport means 130 and fourth by-pass means 131. In an embodiment, oxygen-free packaging device 170 comprises an input tube that receives pre-treated substance 126 from fourth by-pass means 131. In an embodiment, fourth by-pass means 131 is a transport system for transporting solid produce free from any oxygen contamination. Oxygen-free packaging device 170 packages pre-treated product 126 producing a packaged pre-treated product 178. In an embodiment, oxygen-free packing device 170 comprises a pump that provides preferential control over the input flow rate of pre-treated substance 126 into a package. The flow rate of pre-treated substance 125 as controlled by the pump, can be adjusted based on the size of package and the amount of pre-treated substance 126 to be packaged in a given time. After exiting oxygen-free packaging device 170, packaged pre-treated product 178 is preferably transported by third transport means 175 to pasteurization device 180. Pasteurization device 180 converts packaged pre-treated product 178 into packaged pasteurized pre-treated product 179. In an embodiment, after packaged pre-treated substance 178 is pasteurized by pasteurization device 180, fourth transport means 185 transports packaged pasteurized pre-treated substance 179 to distribution device 190 such that the packaged, pasteurized pre-treated substance 179 is distributed to customers

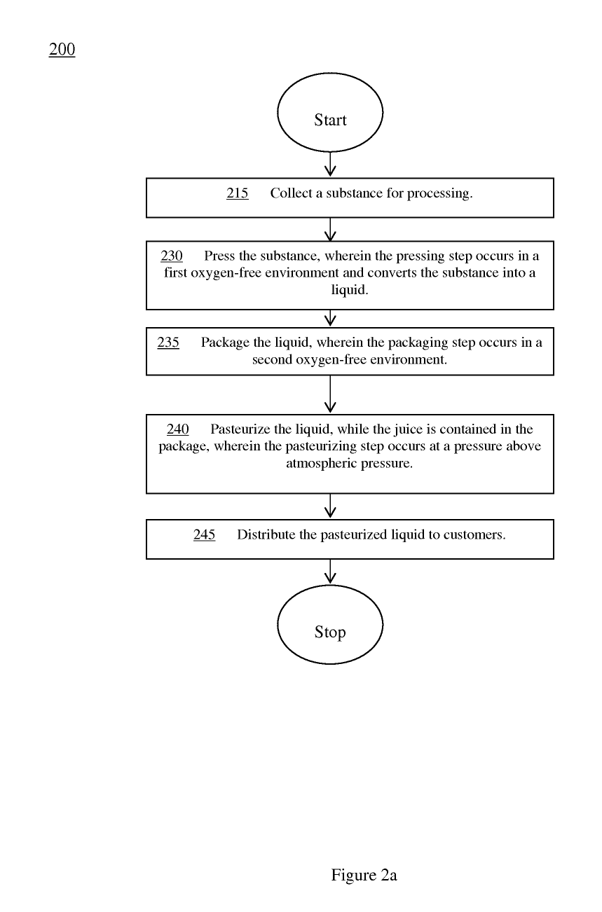

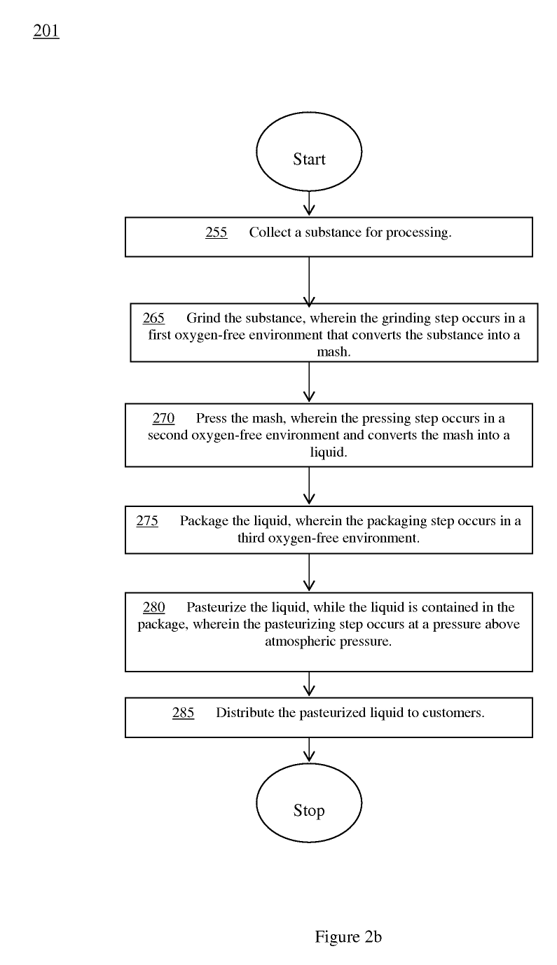

FIG. 2a is a flow diagram that illustrates a method 200 for processing a substance in accordance with an embodiment of the present invention. Initially, intake line 103 collects 215 a substance 104 for processing. After substance 104 is collected 215, second by-pass means 110 transports substance 104 to oxygen-free press 145. Oxygen-free press 145 presses 230 substance 104, wherein the pressing 230 of substance 104 converts substance 104 into liquid 146. Throughout the pressing 230 step, oxygen-free press 145 is maintained under an oxygen-free environment. After pressing 230, third by-pass means 155 transports liquid 146 to oxygen-free packaging device 170. Oxygen free packaging device 170 packages 235 liquid 146, wherein the packaging 235 of liquid 146 occurs in an oxygen-free environment. After liquid 146 is packaged 235, third transport means 175 transports the packaged liquid 176 to pasteurization device 180. Pasteurization device 180 pasteurizes 240 packaged liquid 176, wherein the pasteurization step 240 converts packaged liquid 176 into packaged pasteurized liquid 177. In an embodiment, liquid 146 is pasteurized 240 by pasteurization device 180 while liquid 146 is contained in a package. In an embodiment, pasteurization device 180 pasteurizes 240 packaged liquid 176 in an environment that is maintained at a pressure significantly elevated above atmospheric pressure. After packaged liquid 176 is pasteurized 240, fourth transport means 185 transports packaged, pasteurized liquid 177 to distribution device 190. Distribution device 190 distributes 245 packaged, pasteurized liquid 177 to customers.

FIG. 2b is a flow diagram that illustrates a method 201 for processing a substance in accordance with an embodiment of the present invention. Initially, intake line 103 collects 255 a substance 104 for processing. After substance 104 is collected 255, first by-pass means 120 transports substance 104 to oxygen-free grinder 135. Oxygen-free grinder 135 grinds 265 substance 104, wherein the grinding 265 step converts substance 104 into mash 136. After substance 104 is ground 265 into mash 136, first oxygen-free transport means 140 transports mash 136 to oxygen-free press 145. Oxygen-free press 145 presses 270 mash 136, wherein the pressing 270 of mash 136 converts mash 136 into liquid 146. Throughout the pressing 270 step, oxygen-free press 145 is maintained under an oxygen-free environment. After pressing 270, third by-pass means 155 transports liquid 146 to oxygen-free packaging device 170. Oxygen free packaging device 170 packages 275 liquid 146, wherein the packaging 275 of liquid 146 occurs in an oxygen-free environment. After liquid 146 is packaged 275, third transport means 175 transports the packaged liquid 176 to pasteurization device 180. Pasteurization device 180 pasteurizes 280 packaged liquid 176, wherein the pasteurization step 240 converts packaged liquid 176 into packaged pasteurized liquid 177. In an embodiment, liquid 146 is pasteurized 280 by pasteurization device 180 while liquid 146 is contained in a package. Pasteurization device 180 pasteurizes 280 packaged liquid 176 in an environment that is maintained at a pressure above atmospheric pressure. After packaged liquid 176 is pasteurized 240, fourth transport means 185 transports packaged, pasteurized liquid 177 to distribution device 190. Distribution device 190 distributes 285 packaged, pasteurized liquid 177 to customers.

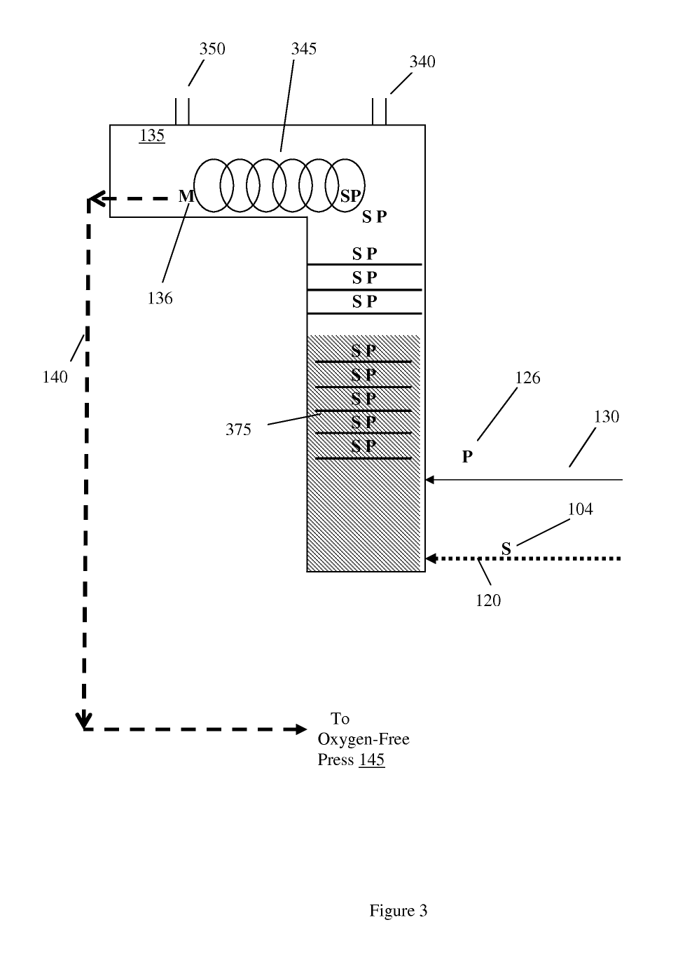

FIG. 3 is a block diagram of an oxygen-free grinder 135 for grinding a substance in accordance with an embodiment of the present invention. Oxygen-free grinder 135 receives either pre-treated substance 126 from second transport means 130 or substance 104 from first by-pass means 120. Once inside the bottom of oxygen-free grinder 135, pre-treated substance 126 or substance 104 is fed into a liquid bath. The bottom of oxygen-free grinder 135 is preferably filled with water. The water is treated with or without material such as enzymes or ascorbic acid. Once inside the bottom of oxygen-free grinder 135, incoming pre-treated substance 126 or substance 104 is fed through the liquid and into the upper portion of oxygen-free grinder 135 by transport means 375. As pre-treated substance 126 or substance 104 is passing into the upper portion of oxygen-free grinder 135, it passes out of liquid and into a portion of the grinder 135 that contains a gas like nitrogen or argon. After leaving the portion of grinder 135 filled with gas, transport means 375 feeds substance 104 or pre-treated substance 126 directly into mechanized grinding teeth 345. Once inside mechanized grinding teeth 345, pre-treated substance 126 or substance 104 is ground and converted to mash 136. The size of mash 136 is determined by the size of mechanized grinding teeth 345 and can be customized based on the type of produce being processes. Once grinding is complete, mash 136 is fed out of oxygen-free grinder 135 by way of first oxygen-free transport means 140. In an embodiment, prior to receiving substance 104 or pre-treated substance 126, oxygen-free grinder 135 is completely purged of any air by way of purge valve 340. While oxygen-free grinder 135 is completely purged of air through purge valve 340, a gas is introduced, by way of feed tube 350, throughout oxygen-free grinder 135. The gas introduced through feed tube 350 is an inert gas, heavier than air, which keeps oxygen from coming in contact with substance 104 or pre-treated substance 126 and thereby preventing oxidation during grinding. In addition, an inserted oxygen sensor provides real-time data, insuring the integrity of an oxygen free environment throughout oxygen-free grinder 135. Throughout the grinding process of substance 104 or pre-treated substance 126, an oxygen-free environment is carefully maintained.

While the invention has been particularly shown and described with reference to a preferred embodiment and various alternate embodiments, it will be understood by persons skilled in the relevant art that various changes in form and details can be made therein without departing from the spirit and scope of the invention.

The invention claimed is:

1. A method for processing a substance comprising:
(a) receiving the substance; and
(b) pressing the substance, wherein the pressing step occurs in a first oxygen-free environment and converts the substance into a liquid; and
(c) packaging the liquid, wherein the packaging step occurs in a second oxygen-free environment and packages the liquid in a package; and
(d) pasteurizing the liquid, while the liquid is contained in the package, wherein the pasteurizing step converts the liquid into a pasteurized liquid, wherein the conversion of the liquid into the pasteurized liquid occurs in an environment maintained at a pressure greater than atmospheric pressure.

2. The method of claim 1, further comprising pre-treating the substance.

3. The method of claim 1, further comprising grinding the substance, wherein the grinding step occurs in a third oxygen-free environment and converts the substance into a mash.

4. The method of claim 2, further comprising grinding the substance, wherein the grinding step occurs in a third oxygen-free environment and converts the substance into a mash.

5. The method of claim 1, further comprising storing the substance in a controlled atmosphere storage environment.

6. The method of claim 2, wherein the pre-treating step occurs in a fourth oxygen-free environment.

7. The method of claim 2, wherein the pre-treating step comprises a combination of coring, sorting, cleaning, de-stoning, de-stemming, freezing, or peeling of the substance.

8. The method of claim 1, wherein the package comprises a self-dispensing tap.

9. The method of claim 1, wherein the package comprises an oxygen free aluminum, plastic, or nylon pouch.

10. The method of claim 1, wherein the pasteurizing step occurs at a pressure significantly greater than atmospheric pressure.

11. The method of claim 9, wherein the aluminum, plastic, or nylon bag comprises a self-dispensing tap.

12. An apparatus for processing a substance comprising:
(a) a receiving means for receiving the substance; and
(b) a pressing means, said pressing means connected to the receiving means, for converting the substance into a liquid, wherein the pressing means maintains a first oxygen-free environment; and
(c) a packaging means, said packaging means connected to the pressing means, for packaging the liquid in a package, wherein the packaging means maintains a second oxygen-free environment; and
(d) a pasteurizing means, said pasteurizing means connected to the packaging means, for pasteurizing the liquid, while the liquid is contained in the package.

13. The apparatus of claim 12, wherein the pasteurizing means maintains a pressure greater than atmospheric pressure when pasteurizing the liquid.

14. The apparatus of claim 12, further comprising a pre-treating means, said pre-treating means connected to said receiving means, for pre-treating the substance.

15. The apparatus of claim 12, further comprising grinding means, said grinding means connected to said receiving means, for converting the substance into a mash, wherein the grinding means maintains a third oxygen-free environment.

16. The apparatus of claim 14, further comprising grinding means, said grinding means connected to said pre-treating means, for converting the substance into a mash, wherein the grinding means maintains a third oxygen-free environment.

17. The apparatus of claim 12, further comprising storing means, said storing means connected to said receiving means, for storing the substance in a controlled atmosphere storage.

18. The apparatus of claim 12, wherein the substance is a fruit or vegetable.

19. The apparatus of claim 12, wherein the receiving means and the pressing means are connected via a first oxygen-free transport means.

20. The apparatus of claim 12, wherein the pressing means and the packaging means are connected via a second oxygen-free transport means.

21. The apparatus of claim 12, wherein the pasteurizing means controls the temperature of the liquid when pasteurizing the liquid.

22. An apparatus for processing a substance comprising:
(a) a receiving means for receiving the substance; and
(b) a pre-treating means, said pre-treating means connected to said receiving means, for converting the substance into a pre-treated substance, wherein the pre-treating means maintains a first oxygen-free environment; and
(c) a packaging means, said packaging means connected to the pre-treating means, for packaging the pre-treated substance in a package, wherein the packaging means maintains a second oxygen-free environment; and
(d) a pasteurizing means, said pasteurizing means connected to the packaging means, for pasteurizing the pre-treated substance while the pre-treated substance is contained in the package.
